(19) United States
(12) Patent Application Publication
(10) Pub. No.: US 2018/0358858 A1
(43) Pub. Date: Dec. 13, 2018

(54) ARMATURE OF ROTARY ELECTRIC MACHINE

(71) Applicant: MITSUBISHI ELECTRIC CORPORATION, Chiyoda-ku, Tokyo (JP)

(72) Inventors: Hironori TSUIKI, Tokyo (JP); Sachiko KAWASAKI, Tokyo (JP)

(73) Assignee: MITSUBISHI ELECTRIC CORPORATION, Chiyoda-ku, Tokyo (JP)

(21) Appl. No.: 15/778,325

(22) PCT Filed: Nov. 22, 2016
(86) PCT No.: PCT/JP2016/084566

§ 371 Date: May 23, 2018

(30) Foreign Application Priority Data
Dec. 8, 2015 (JP) 2015-239323

(51) Int. Cl. H02K 3/32; H02K 1/14; H02K 3/18; H02K 15/02; H02K 15/095; H02K 15/10

(52) U.S. Cl. CPC H02K 3/325; H02K 1/146; H02K 15/105; H02K 15/022; H02K 15/095; H02K 3/18

(57) ABSTRACT

This armature of a rotary electric machine includes: a back yoke portion formed in an annular shape; a plurality of tooth portions formed at an interval in a circumferential direction of the back yoke portion, the plurality of tooth portions protruding in a radial direction; and a coil disposed in a plurality of slots each formed between the tooth portions that are adjacent to each other, and has an insulating portion disposed so as to surround the coil between each slot and the coil and formed from a sheet member, wherein the insulating portion includes lamination portions) in which edges of the sheet member overlap each other, and joint portions in which the lamination portions protrude in both sides in an axial direction to be joined.

### TECHNICAL FIELD

The present invention relates to an armature of a rotary electric machine which maintains a regularly-aligned state of a coil and which allows excellent productivity.

### BACKGROUND ART

In recent years, rotary electric machines such as electric motors and electric generators are required to have a small size, high output, and high efficiency. In order to realize small sizes and high outputs of such rotary electric machines, there is a method in which a conductive wire of a stator is densely inserted in slots provided in an iron core. In order to densely insert the conductive wire, it is necessary to maintain the state where the conductive wire is regularly aligned. Thus, a method in which a regularly-aligned coil is wound up by an insulating member to maintain the regularly-aligned state (see Patent Document 1, for example), or a structure in which a regularly-aligned coil is covered with a sheet (see Patent Document 2, for example) has been proposed. In addition, a rotary electric machine has been proposed in which: an overlapping portion in which insulating members are laminated is provided at a radially inner side, and is pressed by another member, whereby the insulating members are fixed (see Patent Document 3, for example).

### CITATION LIST

### Patent Document

Patent Document 1: Japanese Laid-Open Patent Publication No. 2008-312313

Patent Document 2: Japanese Laid-Open Patent Publication No. 2010-263764

Patent Document 3: Japanese Laid-Open Patent Publication No. 2012-239322

### SUMMARY OF THE INVENTION

### Problems to be Solved by the Invention

The conventional rotary electric machine in Patent Document 1 has a problem that the device for winding up is complicated, resulting in reduced productivity. In the case of the conventional rotary electric machine in Patent Document 2, although there is a description that an adhesive agent is applied to provide fixation, there is no description of an application method for the adhesive agent, and in addition, the adhesive agent needs to be applied in a wide range, which could pose a problem of reduction in productivity. In the case of the conventional rotary electric machine in Patent Document 3, the regularly-aligned state of the coil cannot be maintained before the coil is inserted into slots, and even if the overlapping portion is to be adhered, it is necessary to open the overlapping portion once, apply an adhesive agent, and then press the overlapping portion. Thus, there is a problem that the adhesive agent attaches to the equipment and automation is difficult to be realized. In addition, there is a problem that performing welding by pressing a heated tool could damage the coil and thus cannot be employed.

The present invention has been made in order to solve the above-described problems. An object of the present invention is to provide an armature of a rotary electric machine which maintains the regularly-aligned state of a coil and which allows excellent productivity.

### Solution to the Problems

An armature of a rotary electric machine of the present invention includes:

a back yoke portion in an annular shape;

a plurality of tooth portions protruding in a radial direction at an interval in a circumferential direction of the back yoke portion; and

a coil disposed in a plurality of slots each formed between the tooth portions that are adjacent to each other, wherein

the armature has an insulating portion composed of a sheet member surrounding the coil, between each of the slots and the coil, and

the insulating portion includes a lamination portion in which edges of the sheet member overlap each other, and joint portions respectively protruding to both sides in an axial direction of the lamination portion.

### Effect of the Invention

According to the armature of the rotary electric machine of the present invention, the regularly-aligned state of the coil is maintained, and excellent productivity is attained.

### BRIEF DESCRIPTION OF THE DRAWINGS

FIG. 1 is a perspective view showing a configuration of a stator of a rotary electric machine according to embodiment 1 of the present invention.

FIG. 2 is a side view showing a configuration of the rotary electric machine using the stator shown in FIG. 1.

FIG. 3 is a transverse sectional view showing a cross section in the radial direction of the stator shown in FIG. 1.

FIG. 4 is a perspective view showing a configuration of only an insulating portion shown in FIG. 1.

FIG. 5 is a perspective view showing a state before lamination portions of the insulating portion shown in FIG. 4 are overlapped with each other.

FIG. 6 is a perspective view showing a setting method for setting the insulating portion to the coil in the stator shown in FIG. 1.

FIG. 7 is a perspective view showing a setting method for setting the insulating portion to the coil in the stator shown in FIG. 1.

FIG. 8 is a perspective view showing a setting method for setting the insulating portion to the coil in the stator shown in FIG. 1.

FIG. 9 is an enlarged perspective view showing a state where the insulating portion is set to the coil shown in FIG. 8.

FIG. 10 is a longitudinal cross-sectional view for describing the relationship between the insulating portion and the coil shown in FIG. 9.

FIG. 11 is a longitudinal cross-sectional view for describing a joining method for the joint portion of the insulating portion shown in FIG. 9.

FIG. 12 is a longitudinal cross-sectional view for describing another joining method for the joint portion of the insulating portion shown in FIG. 9.

FIG. 13 is a perspective view showing a state after the insulating portions are set to the coil shown in FIG. 8 and each joint portion is joined.

FIG. 14 is a perspective view showing a step of inserting tooth portions and a back yoke portion to the coil shown in FIG. 13.

FIG. 15 is a transverse sectional view showing a cross section in the radial direction of the stator according to embodiment 2 of the present invention.

FIG. 16 is a perspective view showing a state before the lamination portions of the insulating portion of the stator shown in FIG. 15 are overlapped with each other.

FIG. 17 is a perspective view showing a setting method for setting the insulating portion to the coil of the stator according to embodiment 2 of the present invention.

FIG. 18 is a perspective view showing a setting method for setting the insulating portion to the coil of the stator according to embodiment 2 of the present invention.

FIG. 19 is a longitudinal cross-sectional view for describing the relationship between the insulating portion and the coil shown in FIG. 18.

FIG. 20 is a longitudinal cross-sectional view for describing a joining method for the joint portion of the insulating portion shown in FIG. 19.

FIG. 21 is a longitudinal cross-sectional view for describing another joining method for the joint portion of the insulating portion shown in FIG. 19.

FIG. 22 is a perspective view for describing a manufacturing method for the insulating portion and the coil for the armature of the rotary electric machine according to embodiment 3 of the present invention.

FIG. 23 is a perspective view for describing a manufacturing method for the insulating portion and the coil for the armature of the rotary electric machine according to embodiment 3 of the present invention.

FIG. 24 is a perspective view for describing a manufacturing method for the insulating portion and the coil for the armature of the rotary electric machine according to embodiment 3 of the present invention.

FIG. 25 is a perspective view for describing a manufacturing method for the insulating portion and the coil for the armature of the rotary electric machine according to embodiment 3 of the present invention.

FIG. 26 is a plan view for describing a subsequent manufacturing method for the insulating portion and the coil for the armature shown in FIG. 25.

FIG. 27 is a top view showing a state where the coil shown in FIG. 26 is held by a holding tool.

FIG. 28 is a longitudinal cross-sectional view for describing the relationship between the insulating portion and the coil shown in the FIG. 27.

FIG. 29 is a longitudinal cross-sectional view for describing a joining method for the joint portion of the insulating portion shown in FIG. 28.

FIG. 30 is a longitudinal cross-sectional view for describing another joining method for the joint portion of the insulating portion shown in FIG. 28.

### DESCRIPTION OF EMBODIMENTS

### Embodiment 1

Hereinafter, embodiments of the invention of the present application are described.

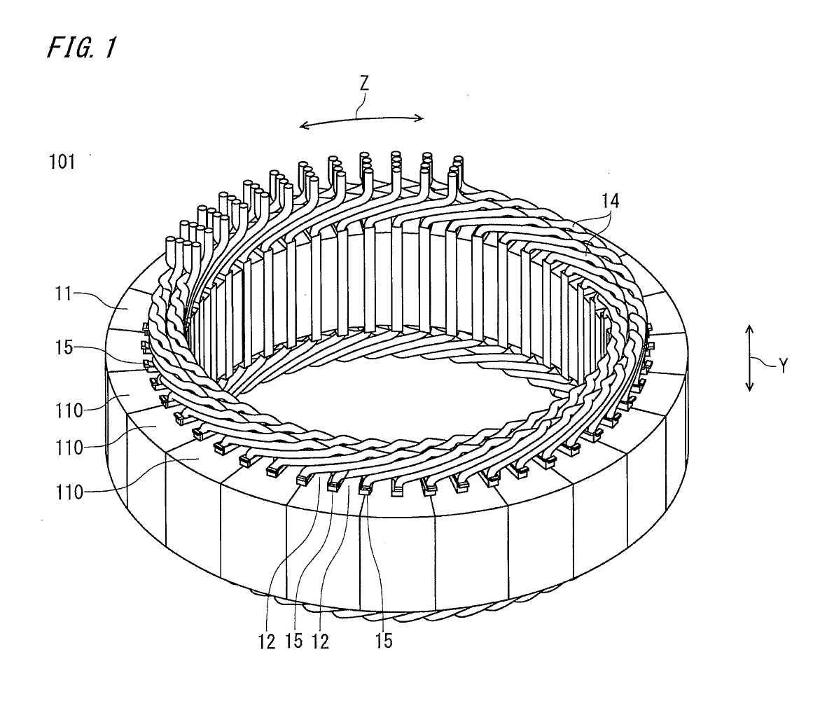

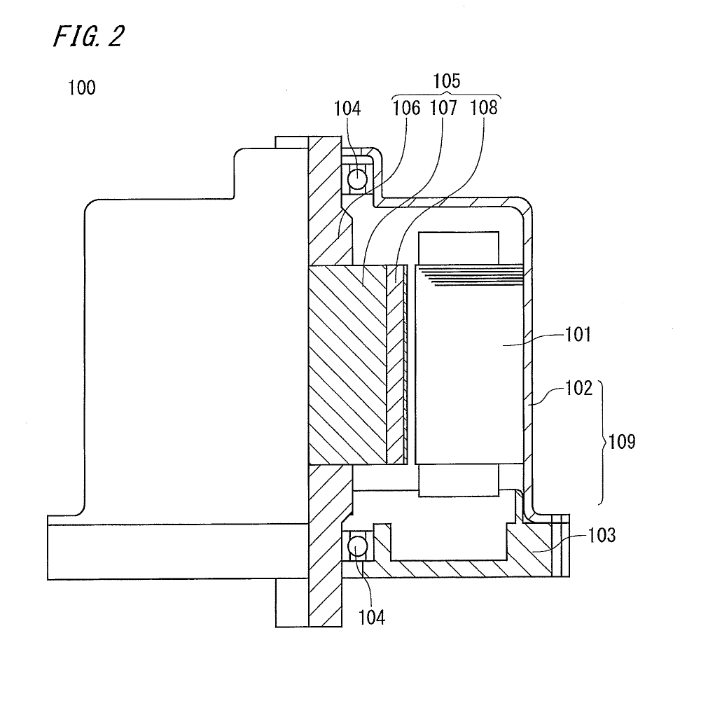

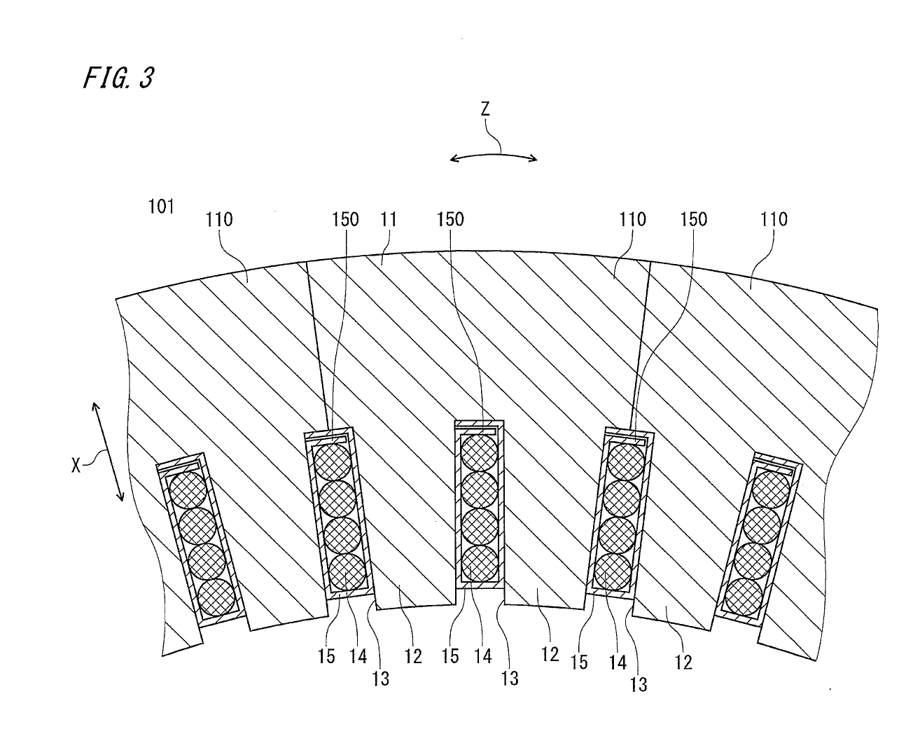

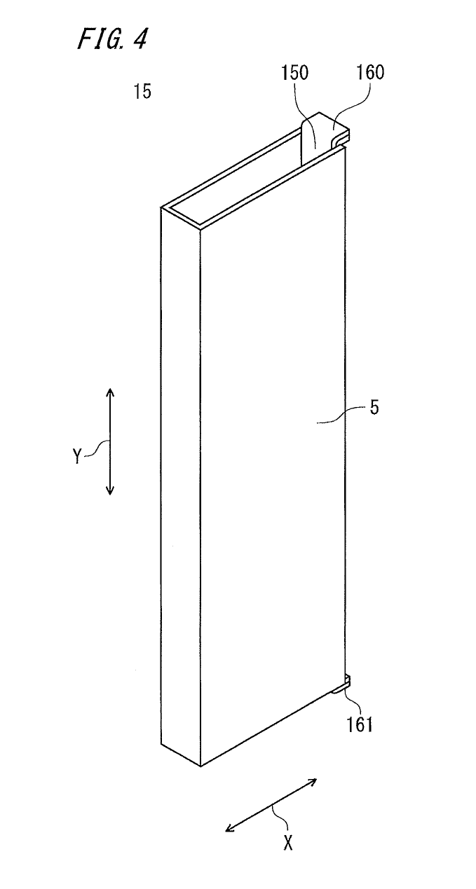

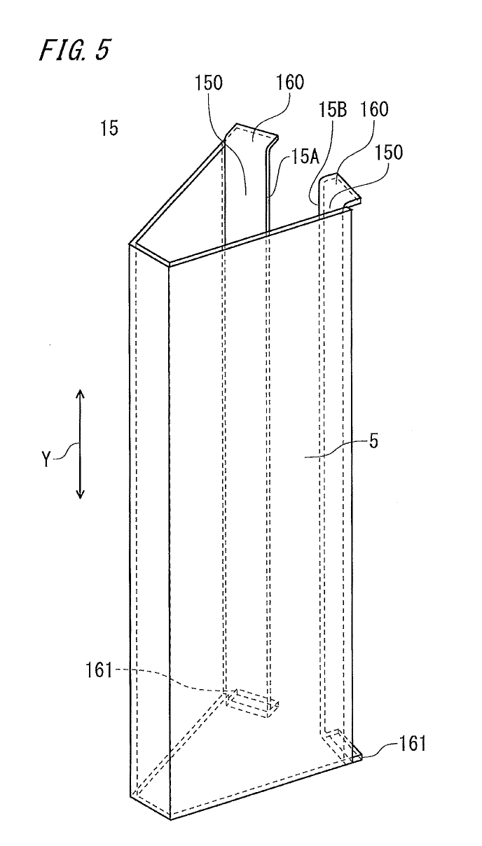

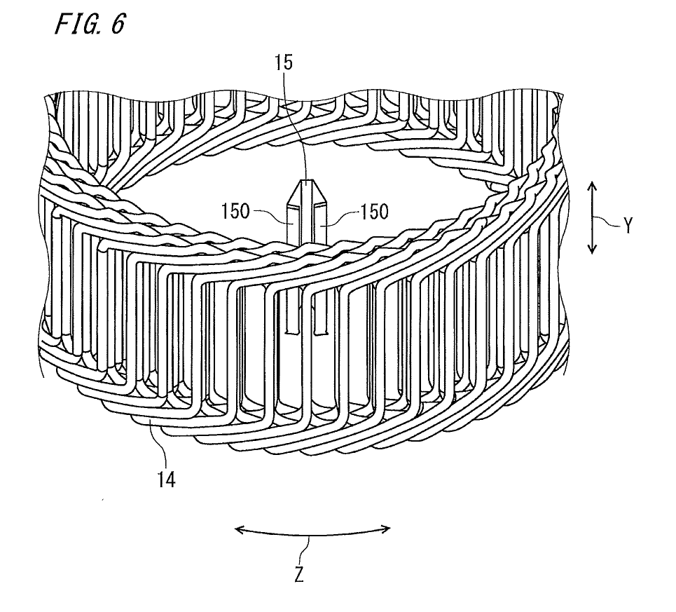

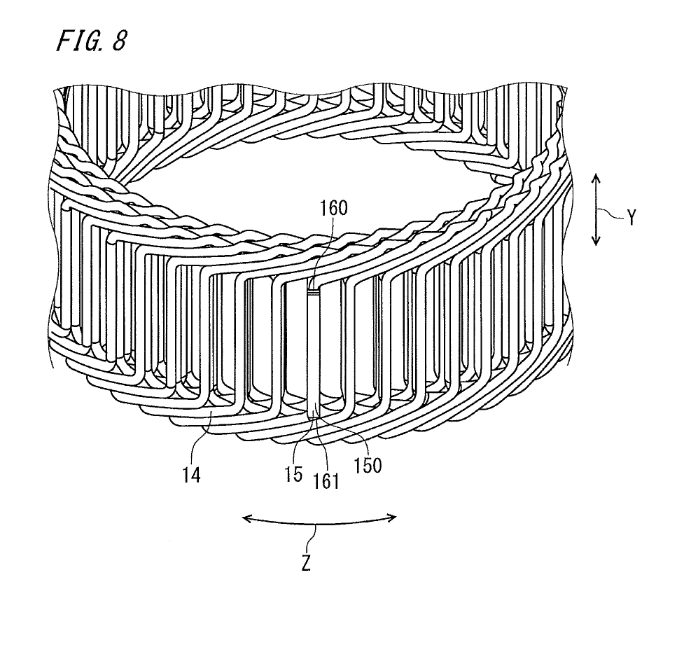

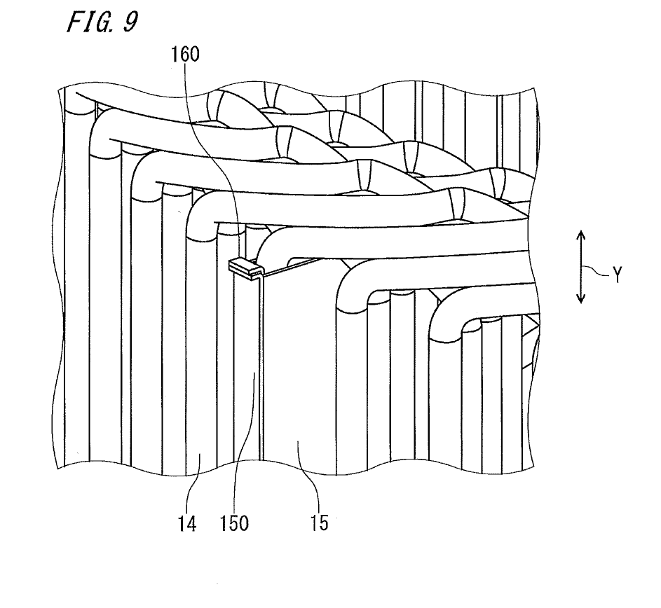

FIG. 1 is a perspective view showing a configuration of a stator of a rotary electric machine according to embodiment 1 of the present invention. FIG. 2 is a side view showing a configuration of the rotary electric machine using the stator shown in FIG. 1. FIG. 3 is a transverse sectional view showing a cross section in the radial direction of the stator shown in FIG. 1. FIG. 4 is a perspective view showing a configuration of only an insulating portion shown in FIG. 1. FIG. 5 is a perspective view showing a state before lamination portions of the insulating portion shown in FIG. 4 are overlapped with each other. FIG. 6 to FIG. 8 are perspective views showing a setting method for setting the insulating portion to the coil in the stator shown in FIG. 1. FIG. 9 is an enlarged perspective view showing a state where the insulating portion is set to the coil shown in FIG. 8.

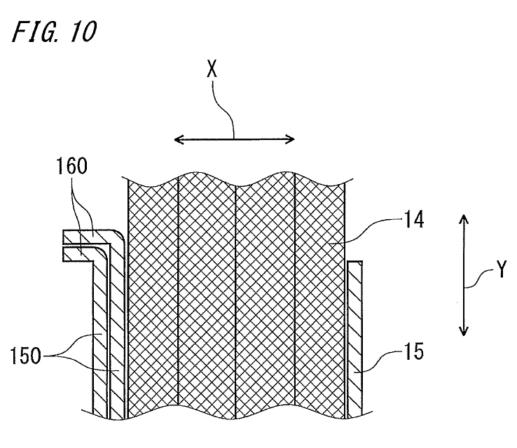

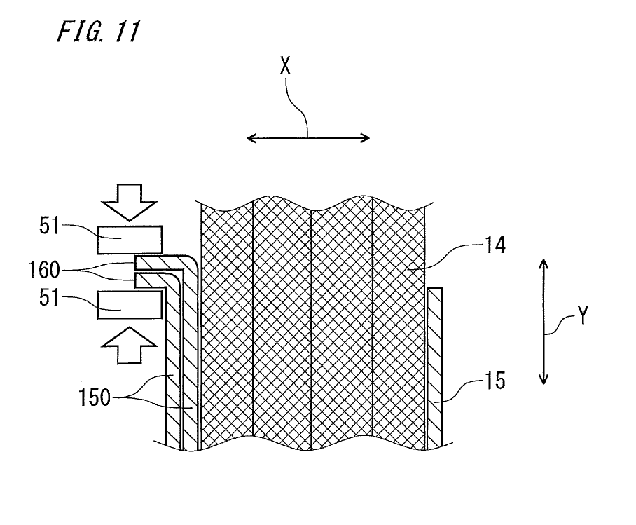

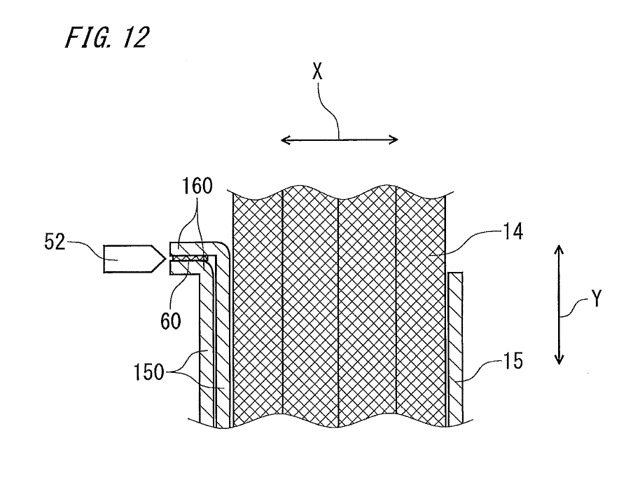

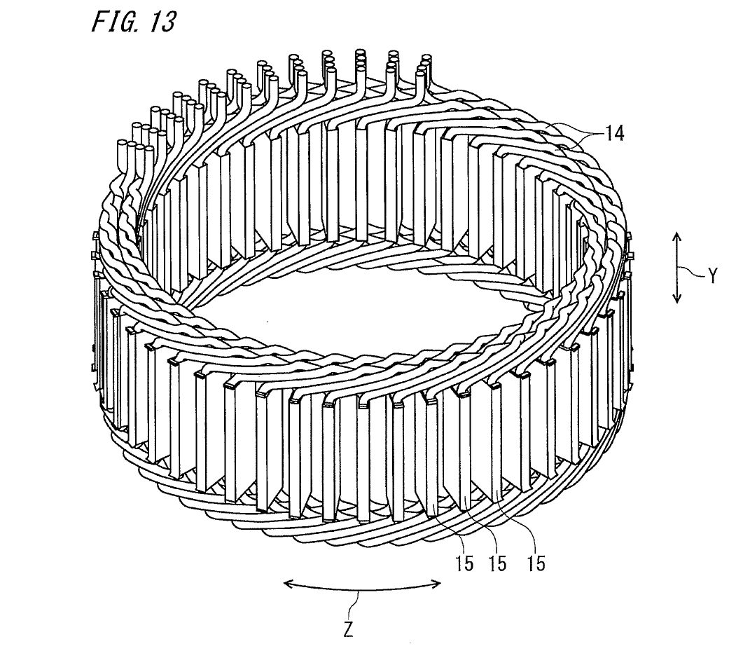

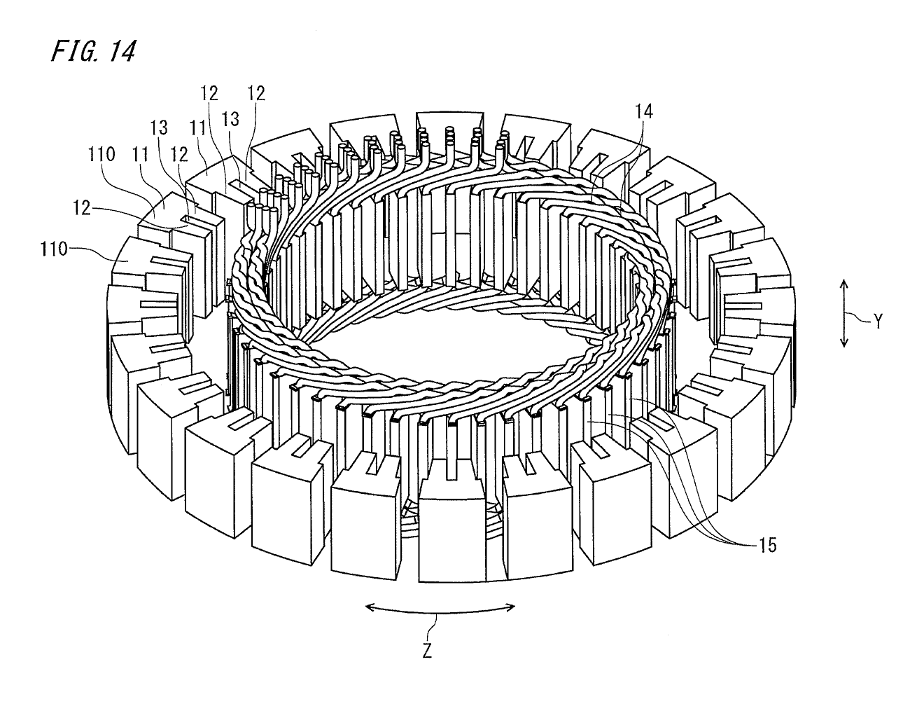

FIG. 10 is a longitudinal cross-sectional view for describing the relationship between the insulating portion and the coil shown in FIG. 9. FIG. 11 is a longitudinal cross-sectional view for describing a joining method for the joint portion of the insulating portion shown in FIG. 9. FIG. 12 is a longitudinal cross-sectional view for describing another joining method for the joint portion of the insulating portion shown in FIG. 9. FIG. 13 is a perspective view showing a state after the insulating portions are set to the coil shown in FIG. 8 and each joint portion is joined. FIG. 14 is a perspective view showing a step of inserting tooth portions and a back yoke portion to the coil shown in FIG. 13.

In FIG. 2, a rotary electric machine 100 includes: a stator 101 as an armature; and a rotor 105 provided in the ring of the stator 101. The rotary electric machine 100 is accommodated in a housing 109 which has: a frame 102 having a cylindrical shape with a bottom; and an end plate 103 closing the opening of the frame 102. The stator 101 is fixed, in a fitted state, to the inside of the cylindrical portion of the frame 102. The rotor 105 is fixed to a rotary shaft 106 which is rotatably supported via bearings 104 to the bottom of the frame 102 and the end plate 103.

The rotor 105 is composed of: a rotor iron core 107 fixed to the rotary shaft 106 inserted at the axial position; permanent magnets 108 which are embedded at the outer circumferential surface side of the rotor iron core 107 and at a predetermined pitch in the circumferential direction, and form magnetic poles. Here, the rotor 105 is shown as of a permanent magnet type, but is not limited thereto. A squirrel cage rotor in which conductive wires not having insulating coats are accommodated in slots and are short-circuited at both sides by short-circuit rings, or a wound rotor in which conductive wires having insulating coats are mounted to slots of a rotor iron core may be used.

In FIG. 1 and FIG. 3, the stator 101 includes: a back yoke portion 11 formed in an annular shape; a plurality of tooth portions 12 formed at equal intervals in a circumferential direction Z on the inner periphery of the back yoke portion 11, the plurality of tooth portions 12 protruding to the inner side in a radial direction X; and a coil 14 disposed in a plurality of slots 13 each formed between the tooth portions 12 that are adjacent to each other.

Here, for convenience of explanation, an example is shown in which the number of poles is eight, the number of slots 13 of the stator 101 is 48, and the coil 14 is a three-phase winding. Therefore, two slots 13 are formed per pole and per phase in the stator 101. The stator 101 is divided by the tooth portions 12 forming magnetic poles, thereby forming the slots 13 into which the coil 14 is inserted. The back yoke portion 11 magnetically connects each tooth portion 12. The back yoke portion 11 (including the tooth portions 12) is composed of 24 divided iron cores 110 which are obtained by dividing the back yoke portion 11 into 24 portions in the circumferential direction Z.

The coil 14 is formed as a wave winding coil in which 12 conductive wires having insulating coats are woven in a meandering manner. The coil 14 is composed of two such wave winding coils, i.e., an inner wave winding coil and an outer wave winding coil, disposed in a concentric manner. In the coil 14, linear-shaped portions for being inserted in a slot 13 are arranged in one line in the radial direction X and are inserted in the slot 13. In the slot 13, the conductive wires forming the coil 14 are regularly aligned in one line (see FIG. 3).

Between each slot 13 and the coil 14, an insulating portion 15 disposed so as to surround the coil 14 and formed from one sheet member 5 is provided. For the sheet member 5 forming the insulating portion 15, for example, use of an insulating resin material such as polyphenylene sulfide or polyethylene terephthalate, or insulating paper formed from an aramid (wholly aromatic polyamide) polymer is conceivable.

As shown in FIG. 4 and FIG. 5, each insulating portion 15 includes: lamination portions 150 in which edges 15A, 15B each extending in an axial direction Y of the sheet member 5 overlap each other; and joint portions 160, 161 in which the lamination portions 150 protrude from the slot 13 at both sides, i.e., at upper and lower sides, in the axial direction Y to be joined. FIG. 5 shows a state of the lamination portions 150 of the insulating portion 15 before the edges 15A, 15B overlap each other.

The insulating portion 15 has a thickness that ensures a necessary insulation distance in accordance with the voltage applied to the coil 14. As shown in FIG. 3, in the insulating portion 15, the lamination portions 150 in which two portions of the sheet member 5 overlap each other are formed at the outermost position in the radial direction X in the slot 13, whereby a necessary creepage distance is ensured. The joint portions 160, 161 are bent in a direction different from the direction in which the slot 13 extends, i.e., here, to the outer side in the radial direction X.

Next, a manufacturing method for the stator of the rotary electric machine according to embodiment 1 configured as described above is described. First, the coil 14 is formed as shown in FIG. 6. Then, in a state where both edges 15A, 15B of the insulating portion 15 formed from the sheet member 5 are opened (separated), the insulating portion 15 is inserted from the inner side in the radial direction X to cover the regularly-aligned linear portions of the coil 14 (hereinafter, referred to as “linear-shaped portion”), i.e., the part to be inserted in the slot 13 later.

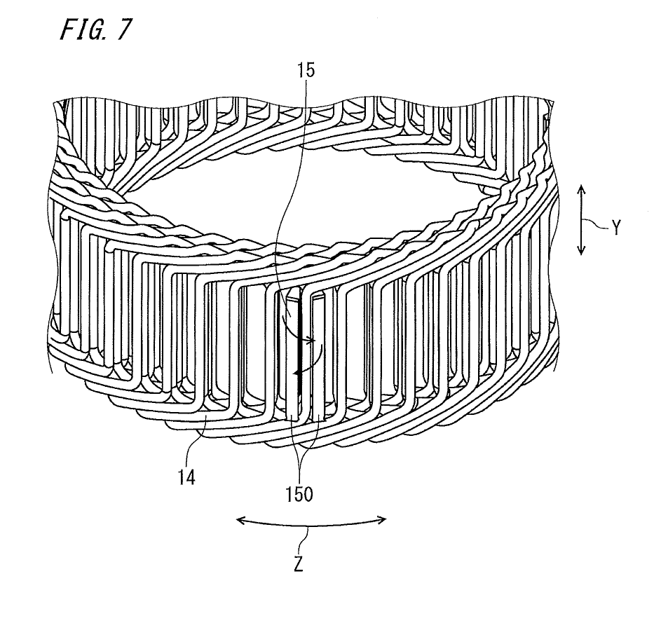

Next, both edges 15A, 15B of the insulating portion 15 are caused to overlap each other in the axial direction Y as shown in FIG. 7, such that the lamination portions 150 are formed as shown in FIG. 8, FIG. 9, and FIG. 10 and the insulating portion 15 surrounds the linear-shaped portion of the coil 14. Next, as shown in FIG. 11, a welding tool 51 of which temperature has reached the melting temperature of the insulating material of the sheet member 5 is pressed against the joint portions 160, 161 from above and below in the axial direction Y. Then, the joint portions 160, 161 are welded to be joined through melting bonding. Then, the linear-shaped portion of the coil 14 is held by the insulating portion 15. As another joining method, as shown in FIG. 12, an adhesive agent 60 is applied between the joint portions 160, 161 from a nozzle 52, thereby joining the joint portions 160, 161 through adhesive bonding.

As described above, since joining is performed at the joint portions 160, 161 having the positional relationship in which the joint portions 160, 161 protrude with respect to the axial direction Y from the slot 13, the welding tool 51 can be easily set. Meanwhile, the adhesive agent can be applied with the joining range limited. When the joint portions 160, 161 are joined through melting bonding, fixation by welding is allowed by applying heat and pressure by means of the welding tool 51, and thus, the productivity is improved.

Then, as shown in FIG. 13, the insulating portion 15 is mounted to each of all the linear-shaped portions of the coil 14. Since joining is performed at the joint portions 160, 161, the insulating portion 15 can maintain the regularly-aligned state of the linear-shaped portion of the coil 14. Next, as shown in FIG. 14, the divided iron cores 110 are inserted from the outer side in the radial direction X into the coil 14 provided with the insulating portions 15 such that the insulating portions 15 are respectively disposed in the slots 13, whereby the stator 101 is formed.

In this manner, the coil 14 can be inserted in the slots 13 between the tooth portions 12 of the divided iron cores 110 in a state where the coil 14 is regularly aligned and fixed by the insulating portions 15. Therefore, the linear-shaped portions of the coil 14 are stably inserted in the slots 13, respectively. Accordingly, deterioration of the insulating portions 15 due to friction between the coil 14 and the tooth portions 12 can be prevented, and the rotary electric machine 100 which has high insulating quality and which allows high productivity can be obtained.

According to the armature of the rotary electric machine according to embodiment 1 configured as described above, the insulating portion for ensuring insulation between the slot and the coil is configured such that: the insulating portion is disposed so as to surround the coil in the slot; and, in the lamination portions in which the edges overlap each other, joining is performed at the joint portions protruding to both sides in the axial direction from the slot. Thus, joining at the joint portions which are formed so as to extend from the slot to the outside and in which portions of the sheet member overlap each other is enabled, and formation of the joint portions is facilitated. Accordingly, the coil can be held while the regularly-aligned state of the coil in the slots is ensured, and the productivity is improved.

Since the joint portions are bent in a direction different from the direction in which the slot extends, the joining step of the joint portions can be easily performed without being hindered by the coil inserted in the slot, and the joint portions can be disposed without influencing the coil.

In the present embodiment, an example has been shown in which the joint portions are provided in the radial direction and the joint portions are bent in the radial direction different from the direction in which the slot extends. However, not limited thereto, it is also possible to: provide the joint portions in the circumferential direction in such a manner as not to cause influence on the coil; bend the joint portions in the circumferential direction; and perform the joining step. By bending the joint portions in the radial direction or the circumferential direction as described above, the joining step can be easily performed.

In the description above, an example has been shown in which the joint portions are maintained to be bent in the radial direction or the circumferential direction also after having been subjected to the joining step. However, not limited to thereto, for example, after the joint portions are joined in the joining step, the joint portions may be restored to extend in the axial direction, that is, the joint portions may be caused to extend in the axial direction from the lamination portions.

Since the joint portions are joined through melting bonding, formation of the joint portions is facilitated, and a reliable joined part can be formed.

Alternatively, since the joint portions are joined through adhesive bonding, availability of the material of the sheet member can be increased.

### Embodiment 2

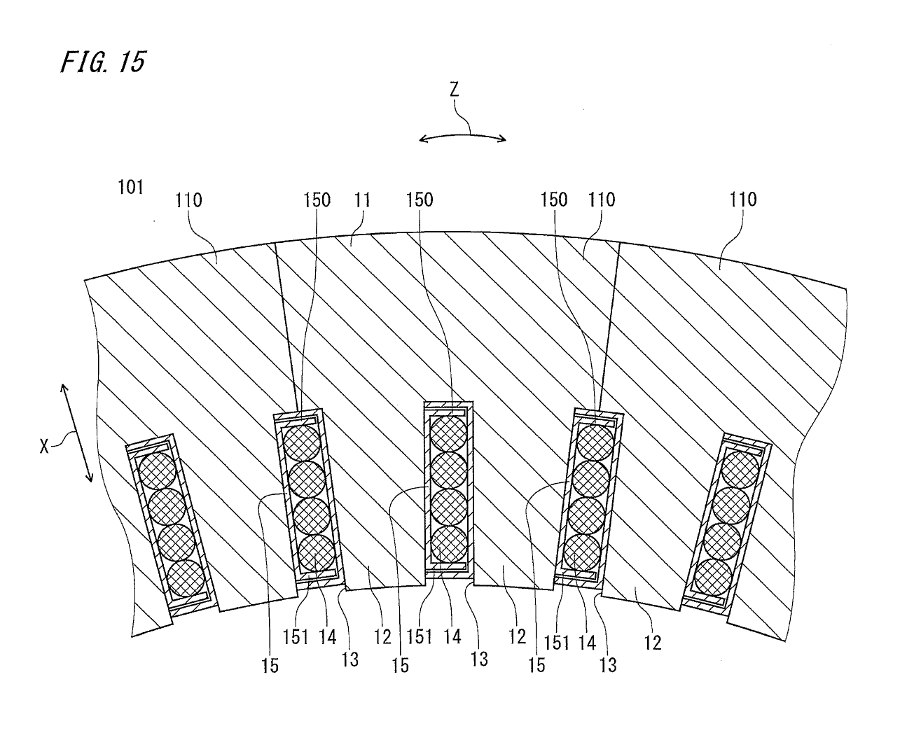

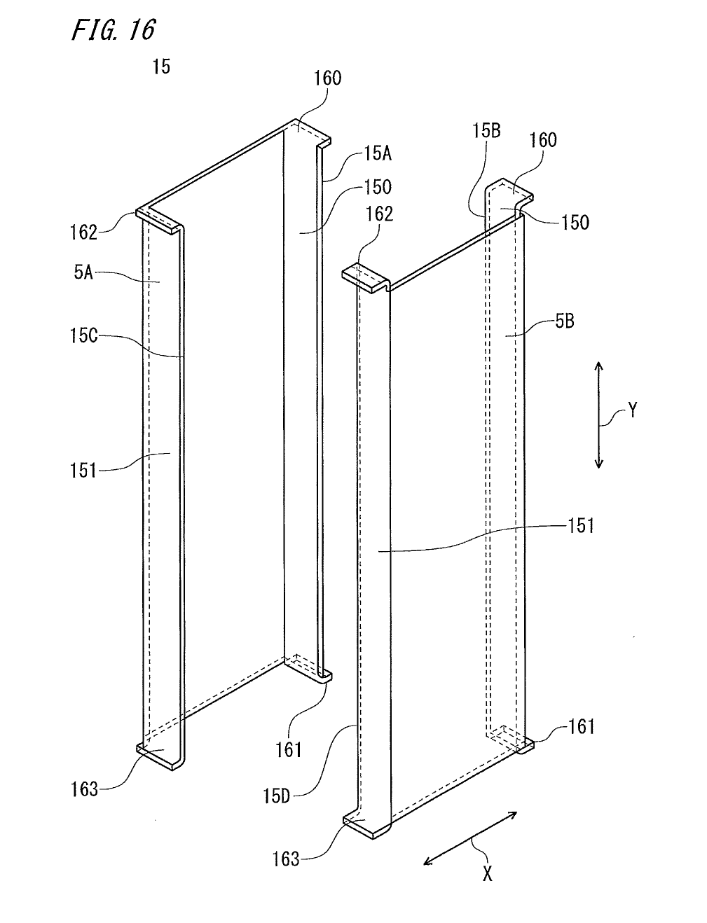

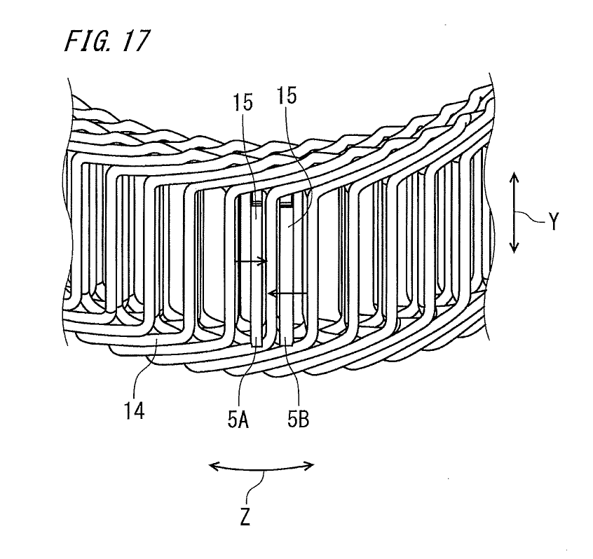

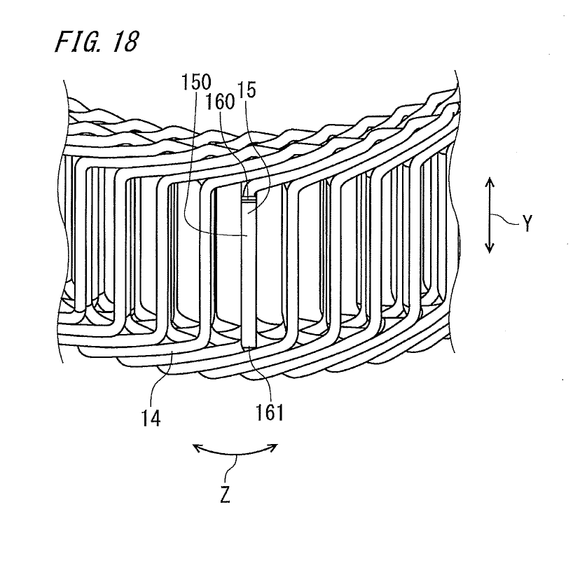

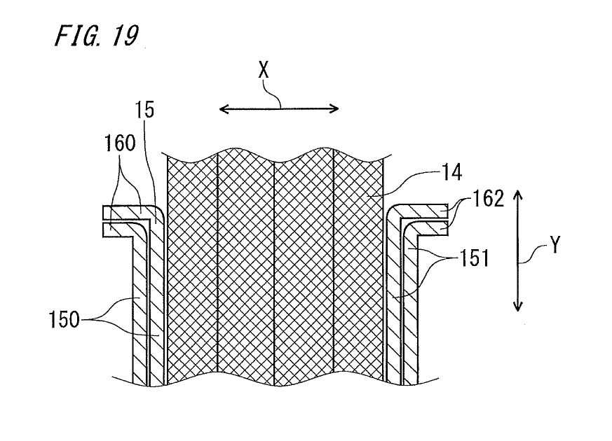

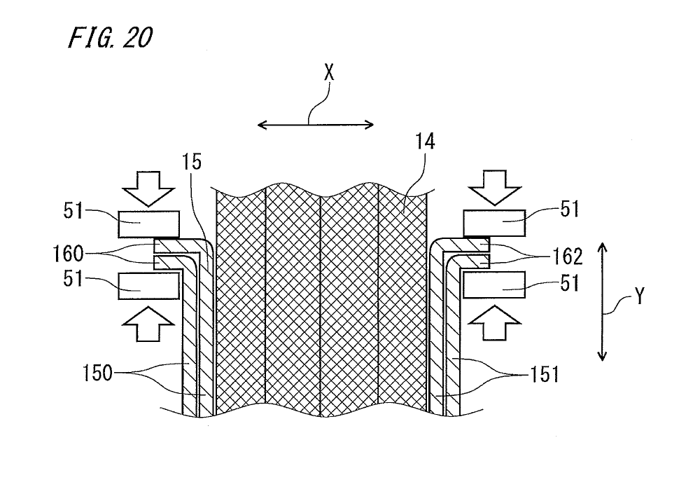

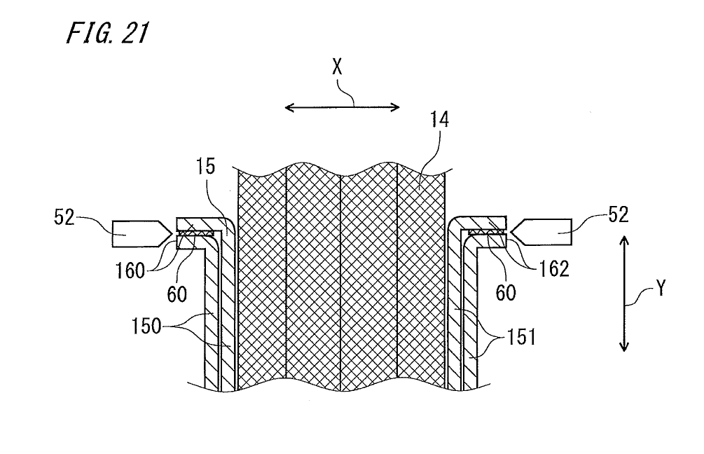

FIG. 15 is a transverse sectional view showing a cross section in the radial direction of the stator according to embodiment 2 of the present invention. FIG. 16 is a perspective view showing a state before the lamination portions of the insulating portion shown in FIG. 15 are overlapped with each other. FIG. 17 and FIG. 18 are perspective views each showing a step of setting the insulating portion to the coil of the stator according to embodiment 2 of the present invention. FIG. 19 is a longitudinal cross-sectional view for describing the relationship between the insulating portion and the coil shown in FIG. 18. FIG. 20 is a longitudinal cross-sectional view for describing a joining method for the joint portion of the insulating portion shown in FIG. 19. FIG. 21 is a longitudinal cross-sectional view for describing another joining method for the joint portion of the insulating portion shown in FIG. 19.

In FIG. 15 and FIG. 16, the same components as those in the above embodiment 1 are denoted by the same reference characters, and description thereof is omitted. In the present embodiment 2, each insulating portion 15 is composed of two sheet members 5A, 5B divided in the axial direction Y. Thus, the insulating portion 15 has edges 15C, 15D, in addition to the edges 15A, 15B extending in the axial direction Y. Then, in the insulating portion 15, lamination portions 150, 151 are formed at two positions, i.e., the lamination portions 150 in which the edges 15A, 15B overlap each other, and lamination portions 151 in which edges 15C, 15d overlap each other.

The joint portions 160, 161 are formed in the lamination portions 150, and joint portions 162, 163 are formed in the lamination portions 151. In the joint portions 162, 163, the lamination portions 151 protrude from the slot 13 at both sides, i.e., at upper and lower sides, in the axial direction Y to be joined. The joint portions 162, 163 are bent in a direction different from the direction in which the slot 13 extends, i.e., here, to the inner side in the radial direction X. As shown in FIG. 15, in the insulating portion 15, the lamination portions 150 in which the two sheet members 5A, 5B overlap each other is formed at the outermost position in the radial direction X in the slot 13, and further, the lamination portions 151 in which the two sheet members 5A, 5B overlap each other is formed at the innermost position in the radial direction X in the slot 13, whereby a necessary creepage distance is ensured.

Next, a manufacturing method for the stator of the rotary electric machine according to embodiment 2 configured as described above is described. First, similarly to the above embodiment 1, the coil 14 is formed as shown in FIG. 17. Then, in a state where both edges 15A, 15B of the sheet members 5A, 5B of the insulating portion 15 are separated from each other and both edges 15C, 15D are separated from each other, the insulating portion 15 is inserted from the inner side or the outer side in the radial direction X to cover the linear-shaped portion of the coil 14, i.e., the part to be inserted in the slot 13 later.

Next, as shown in FIG. 18 and FIG. 19, both edges 15A, 15B and both edges 15C, 15D of the sheet members 5A, 5B of the insulating portion 15 are moved relative to each other from the circumferential direction Z, so as be overlapped with each other in the axial direction Y to form the lamination portions 150, 151 such that the insulating portion 15 surrounds the linear-shaped portion of the coil 14. Next, as shown in FIG. 20, the welding tool 51 of which temperature has reached the melting temperature of the insulating material of the sheet members 5A, 5B is pressed against the joint portions 160, 161, 162, 163 from above and below in the axial direction Y. Then, the joint portions 160, 161, 162, 163 are welded to be joined through melting bonding. Then, the linear-shaped portion of the coil 14 is held by the insulating portion 15. As another joining method, as shown in FIG. 21, the adhesive agent 60 is applied between the joint portions 160, 161, 162, 163 from the nozzle 52, thereby joining the joint portions 160, 161, 162, 163 through adhesive bonding.

As described above, since joining is performed at the joint portions 160, 161, 162, 163 having the positional relationship in which the joint portions 160, 161, 162, 163 protrude with respect to the axial direction Y from the slot 13, the welding tool 51 can be easily set. Meanwhile, the adhesive agent can be applied with the joining range limited. When the joint portions 160, 161, 162, 163 are joined through melting bonding, fixation by welding is allowed by applying heat and pressure by means of the welding tool 51, and thus, the productivity is improved. Thereafter, through the same steps as those in the above embodiment 1, the stator 101 is formed.

It is needless to say that the armature of the rotary electric machine according to embodiment 2 configured as described above exhibits effects similar to those in the above embodiment 1. In addition, since the insulating portion is formed from two sheet members divided in the axial direction, the lamination portions are formed at two positions, and the joint portions are formed at the lamination portions at each of the two positions, the insulating portion can be set, without being deformed, to the coil, when compared with the above embodiment 1. Thus, the degree of freedom in setting the insulating portion to the coil is increased, and thus, the setting can be easily performed. Accordingly, without any complicated assembling step, automation can be easily performed, and the productivity is improved.

### Embodiment 3

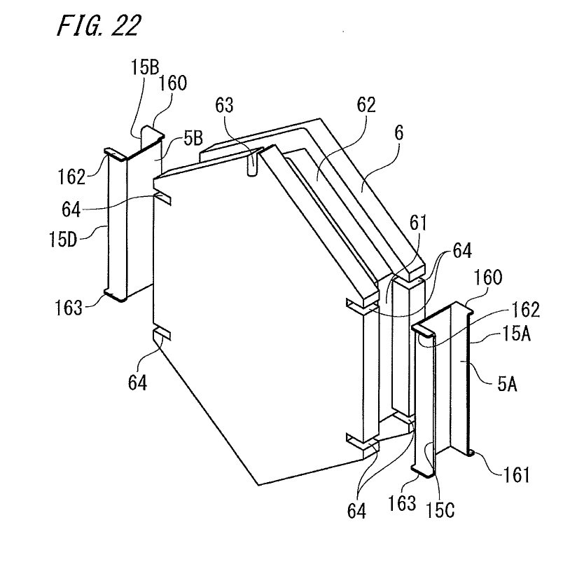

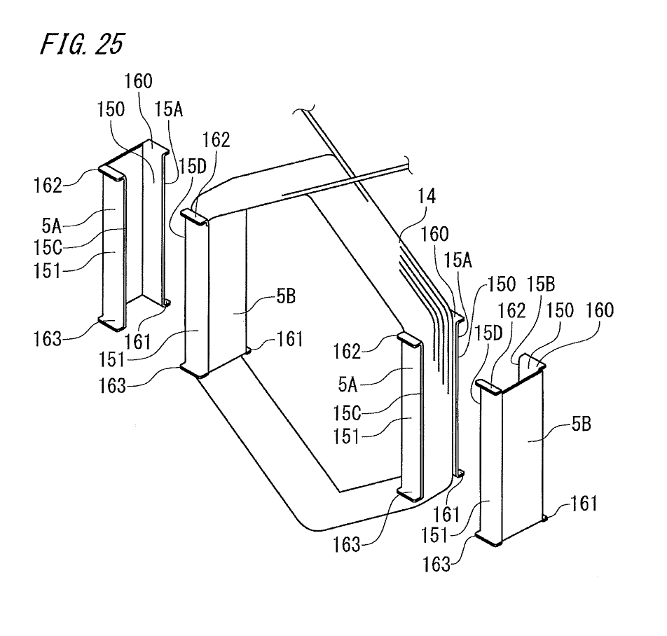

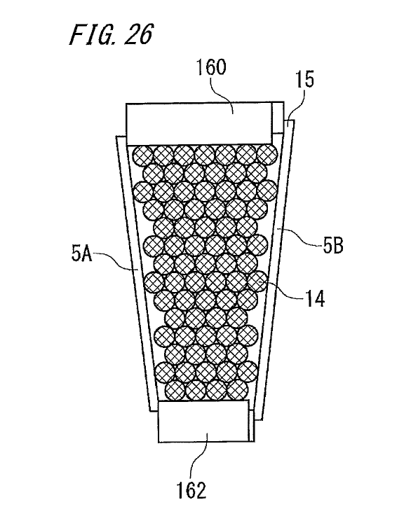

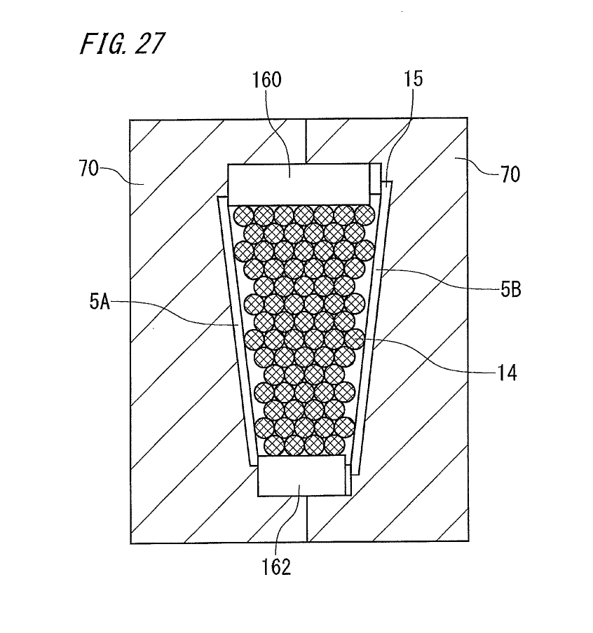

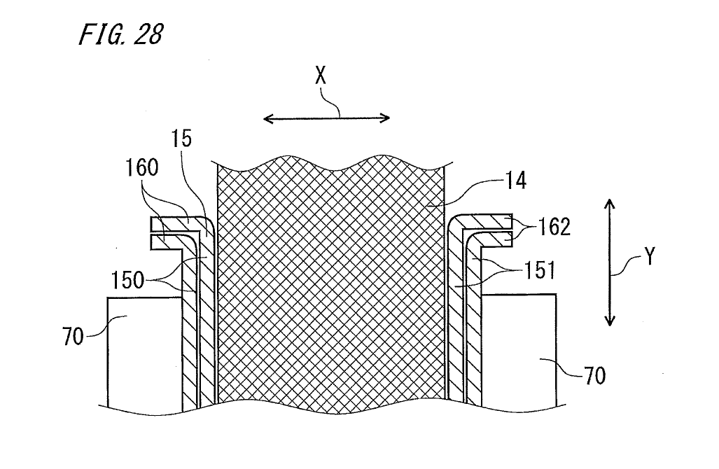

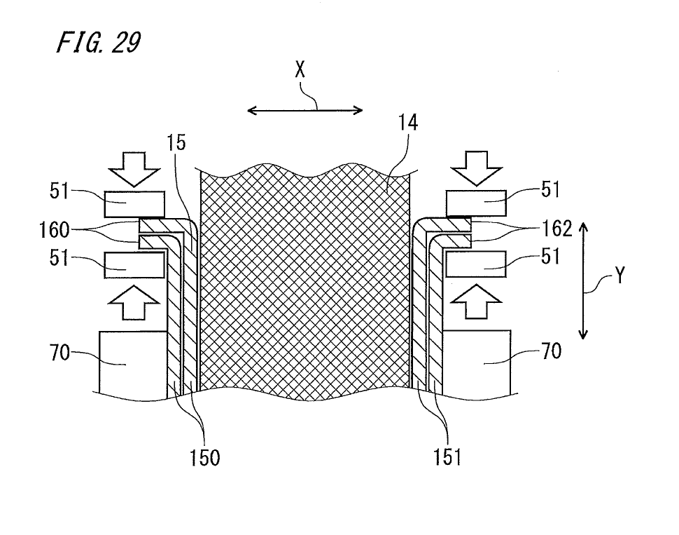

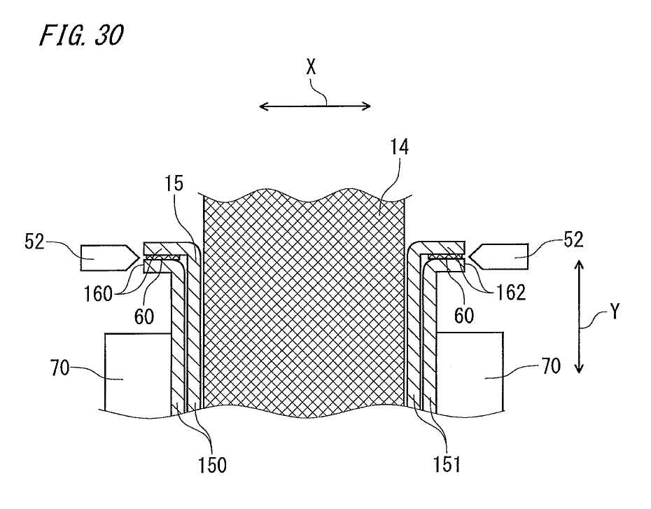

FIG. 22 through FIG. 25 are perspective views for describing a manufacturing method for the insulating portion and the coil for the armature of the rotary electric machine according to embodiment 3 of the present invention. FIG. 26 is a plan view for describing a subsequent manufacturing method for the insulating portion and the coil for the armature shown in FIG. 25. FIG. 27 is a top view showing a state where the coil shown in FIG. 26 is held by a holding tool. FIG. 28 is a longitudinal cross-sectional view for describing the relationship between the insulating portion and the coil shown in the FIG. 27. FIG. 29 is a longitudinal cross-sectional view for describing a joining method for the joint portion of the insulating portion shown in FIG. 28. FIG. 30 is a longitudinal cross-sectional view for describing another joining method for the joint portion of the insulating portion shown in FIG. 28.

In the drawing, the same components as those in the above embodiments are denoted by the same reference characters, and description thereof is omitted. In the present embodiment 3, an example is described in which a ring coil formed by coaxially winding plurality of times a conductive wire provided with an insulating coat is used as the coil 14. The other configurations are the same as those in the above embodiment 2, and thus, description thereof is omitted. In FIG. 22, a winding frame 6 is for forming the coil 14. In the winding frame 6, linear portions 61 are formed at two positions at the left side and the right side on the drawing sheet, end portions 62 are formed at two positions at the upper side and the lower side on the drawing sheet, an introduction groove 63 is formed at one position, and fixation grooves 64 are formed at eight positions.

The linear portions 61 are each a portion for forming the linear-shaped portion of the coil 14 to be inserted in the slot 13, and are formed at two positions in the winding frame 6. That is, the linear-shaped portions at two positions of the coil 14 which are respectively inserted in the slots 13 at two positions are made. The end portions 62 are portions for forming coil end portions at which, when the coil 14 is set to the iron core, the conductive wires inserted in the slots 13 are electrically joined to each other at the upper end and the lower end in the axial direction of the iron core. The introduction groove 63 is a portion for introducing the beginning of the winding of the conductive wire. The fixation grooves 64 are portions formed at the upper side and the lower side in the axial direction Y of each linear portion 61, in order to support and fix, to the winding frame 6, the joint portions 160, 161, 162, 163, of either one of the sheet members 5A, 5B forming the insulating portion 15.

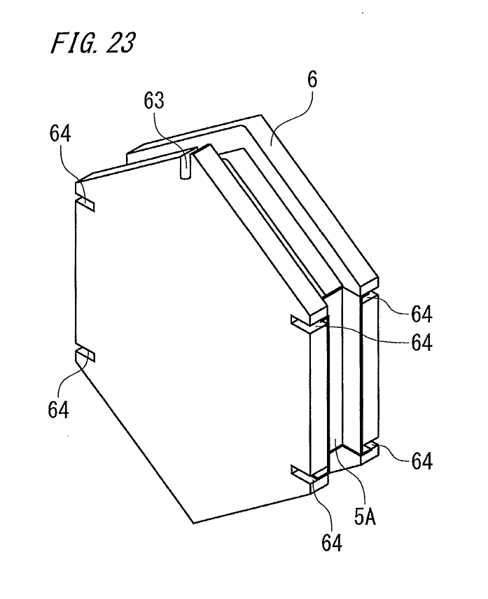

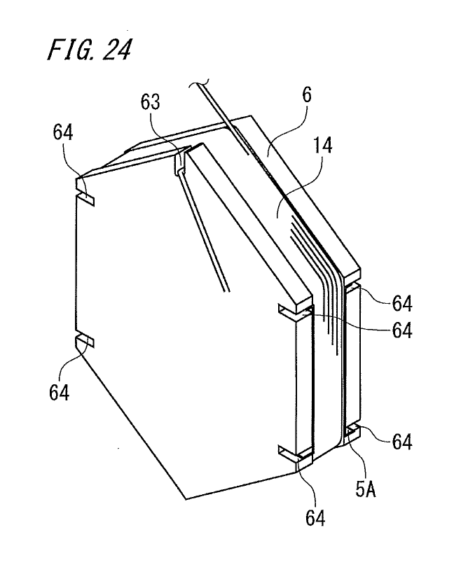

Next, a manufacturing method for the armature of the rotary electric machine according to embodiment 3 configured as described above is described. First, as shown in FIG. 22, the joint portions 160, 161, 162, 163 of the sheet members 5A, 5B of the insulating portions 15 are respectively inserted in the fixation grooves 64 of the winding frame 6. Then, as shown in FIG. 23, the sheet members 5A, 5B of the insulating portions 15 are respectively fixed and supported by the winding frame 6. Next, as shown in FIG. 24, the conductive wire covered with an insulating coat is introduced from the introduction groove 63 and the conductive wire is wound, or the winding frame 6 is rotated, whereby the conductive wire is wound up on the winding frame 6 and the coil 14 is made.

Next, when the coil 14 has been wound up, as shown in FIG. 25, the winding frame 6 is removed from the coil 14, with the sheet members 5A, 5B of the insulating portions 15 left at the coil 14 side. Next, both edges 15B, 15A and both edges 15D, 15C of the other of the sheet members 5B, 5A of the insulating portions 15 are moved relative to each other, so as to be overlapped with each other in the axial direction Y, to form the lamination portions 150, 151 such that each insulating portion 15 surrounds the linear-shaped portion of the coil 14 (FIG. 26).

Next, since the joint portions 160, 161, 162, 163 are not yet joined in this state, a holding tool 70 is set so as to maintain the regularly aligned state of the coil 14, and temporarily maintain the regularly aligned state as shown in FIG. 27 and FIG. 28. Next, similarly to the above embodiment 2, as shown in FIG. 29, the welding tool 51 of which temperature has reached the melting temperature of the insulating material of the sheet members 5A, 5B is pressed against the joint portions 160, 161, 162, 163 from above and below in the axial direction Y. Then, the joint portions 160, 161, 162, 163 are welded to be joined through melting bonding. Then, the linear-shaped portion of the coil 14 is held by the insulating portion 15.

As another joining method, as shown in FIG. 30, the adhesive agent 60 is applied between the joint portions 160, 161, 162, 163 from the nozzle 52, thereby joining the joint portions 160, 161, 162, 163 through adhesive bonding. Then, the holding tool 70 is removed. Since the joint portions 160, 161, 162, 163 have been joined at this time point, the shape of the linear-shaped portion of the coil 14 can be maintained by the insulating portion 15. Thereafter, through the same steps as those in the above embodiments, the stator 101 is formed.

The armature of the rotary electric machine according to embodiment 3 configured as described above can exhibit effects similar to those in the above embodiments, even when the shape of the coil is different.

In addition, since the sheet members divided in advance are fixed to the winding frame, the winding work can be performed without the sheet members obstructing the coil, and thus, the productivity is improved.

In each of the above embodiments, an example is shown in which the divided iron cores divided in the circumferential direction are used. However, in the present embodiment 3, the coil described in the present embodiment 3 can be inserted in slots formed in a single iron core which is not divided in the circumferential direction.

It is noted that, within the scope of the present invention, the above embodiments may be freely combined with each other, or each of the above embodiments may be modified or simplified as appropriate.

1. An armature of a rotary electric machine comprising:
a back yoke portion in an annular shape;
a plurality of tooth portions protruding in a radial direction at an interval in a circumferential direction of the back yoke portion; and
a coil disposed in a plurality of slots each formed between the tooth portions that are adjacent to each other, wherein
the armature has an insulating portion composed of a sheet member surrounding the coil, between each of the slots and the coil, and
the insulating portion comprises a lamination portion in which edges of the sheet member overlap each other, and joint portions respectively protruding to both sides in an axial direction of the edges in the lamination portion, each joint portion being in a form of a lamination.

2. The armature of the rotary electric machine according to claim 1, wherein each joint portion is bent in the circumferential direction or the radial direction.

3. The armature of the rotary electric machine according to claim 1, wherein
the insulating portion is formed from two sheet members that are divided,
the lamination portion is formed at two positions, and
the joint portions are formed at each of the lamination portions at the two positions.

4. The armature of the rotary electric machine according to claim 1, wherein
each joint portion is formed through melting bonding.

5. The armature of the rotary electric machine according to claim 1, wherein
each joint portion is formed through adhesive bonding.

6. The armature of the rotary electric machine according to claim 2, wherein
the insulating portion is formed from two sheet members that are divided,
the lamination portion is formed at two positions, and
the joint portions are formed at each of the lamination portions at the two positions.

7. The armature of the rotary electric machine according to claim 2, wherein
each joint portion is formed through melting bonding.

8. The armature of the rotary electric machine according to claim 2, wherein
each joint portion is formed through adhesive bonding.

9. The armature of the rotary electric machine according to claim 3, wherein
each joint portion is formed through melting bonding.

10. The armature of the rotary electric machine according to claim 3, wherein
each joint portion is formed through adhesive bonding.
